(19) United States
(12) Patent Application Publication
(10) Pub. No.: US 2010/0288791 A1
(43) Pub. Date: Nov. 18, 2010

(54) DISPENSER

(75) Inventors: Mikko Myyrylainen, Helsinki (FI); Veijo Makinen, Helsinki (FI); David Borg, Helsinki (FI)

Correspondence Address: BROOKS KUSHMAN P.C., 1000 TOWN CENTER, TWENTY-SECOND FLOOR, SOUTHFIELD, MI, 48075, US

(73) Assignee: BARFIX OY, Helsinki (FI)

(21) Appl. No.: 12/301,886

(22) PCT Filed: May 22, 2007
(86) PCT No.: PCT/FI07/50289

§ 371 Date: Nov. 21, 2008

(30) Foreign Application Priority Data
May 22, 2006 (FI) 20060503

(51) Int. Cl. B67D 7/86; B67D 7/80

(52) U.S. Cl. 222/113; 222/146.6

(57) ABSTRACT

The invention relates to a dispenser for dispensing cooled alcoholic drinks. In accordance with the invention, the dispenser comprises a alcoholic drink container, a cooler for cooling the alcoholic drink, a display container for displaying the served alcoholic drink, a pump for circulating alcoholic drink from the alcoholic drink container through the cooler to the display container and back to the alcoholic drink container, and a dispensing device connected to alcoholic drink circulation for dispensing a drink.

### FIELD OF THE INVENTION

The invention relates to a dispenser as defined in the preamble of claim 1 for displaying and serving cooled alcoholic drinks.

### BACKGROUND OF THE INVENTION

Certain alcoholic drinks, such as for instance vodkas, cognacs, tequilas, whiskies and herb liquors, are usually served very cold, such that the service temperature is below 0° C., usually from −5 to −15° C. These serve temperatures are most often achieved by serving the alcoholic drinks over ice or by keeping the bottles in sufficiently cold cabinets and taking them out just for serving.

Also, different dispensing devices have been developed, in which a circulating cooling glycol flow is used for cooling the alcoholic drink coming from an external container prior to drawing the drink from a tap into a glass. One such dispensing device has been described in patent application WO2006/043910. Towers of different size and shape, equipped with a tap, are also known, in which towers the served drink is guided through a cooling glycol sheath before dispensing the drink from the tap into a glass.

Furthermore, towers using water circulation and equipped with a beer tap are known from the prior art, in which towers the beer to be dispensed is cooled by circulating cold water. A similar structure would certainly also work when dispensing for instance white wine or sweet drinks.

The prior art has two drawbacks. Firstly, if one wishes to use known brands and trademarks, such as the names, the logos or the bottle shapes of alcoholic or other alcoholic drinks, as part of their marketing, the products must be kept in their original bottles. In this case, the bottles must be kept in freezers or other cold stores and may be taken out only for use. Even though placed in glass cabinets, such as is also known, they are still in the background and dark at the bar. Secondly, if the alcoholic drinks are displayed in cooling taps at the most visible place of the bar counter, the drinks are drawn from containers under the counter, in which case one is not able to take advantage of all aspects associated with the reputation of the alcoholic drink brand.

It is a commonly known fact that about 70% of the customers coming to a restaurant do not know, what they are going to order. It is therefore of the utmost importance that all aspects associated with the reputation of the alcoholic drink, such as the brand name, the logo, the color, the appearance of the package, etc. distinguishing the product even minutely from other similar products, are as well presented as possible.

### OBJECTIVE OF THE INVENTION

The objective of the invention is to eliminate the drawbacks referred to above.

A specific objective of the invention is to disclose a novel dispenser for alcoholic drinks which are served very cold, i.e. at below 0° C., possible to be implemented as a solution well presented at the bar counter and displaying the whole brand of the alcoholic drink.

### SUMMARY OF THE INVENTION

The dispenser in accordance with the invention is characterized by what has been presented in claim 1.

The dispenser in accordance with the invention is intended for cooling alcoholic drinks to below 0° C. temperatures, and for displaying and dispensing such drinks. According to the invention, the dispenser comprises a product container containing the alcoholic drink to be dispensed. The dispenser further comprises a cooler for cooling the alcoholic drink and keeping it below the desired temperature, at least below 0° C., and a display container for displaying the cooled alcoholic drink to be served at a clearly visible place, such as at the bar counter. The dispenser further comprises a pump and a pipework used for circulating the alcoholic drink from the container through the cooler to the display container and back to the alcoholic drink container, and a dispensing device connected to alcoholic drink circulation for drawing and dispensing a drink from a tap. In accordance with the invention, humidity of the ambient air thus builds up on the outer surface of the display container forming a layer of ice on said surface.

Preferably, the pump is arranged between the alcoholic drink container and the cooler, although other positions, such as after the cooler, may also be considered. The pump may be continuously working, i.e. circulating the alcoholic drink through the system at a continuous and steady flow rate. This ensures that the alcoholic drink to be dispensed is isothermal at all times. The other option is to pump in cycles, i.e. the pump is arranged to work at even intervals, such as for example from every 1 to 3 minutes, from 1 to 3 minutes at a time.

The continuous circulation may flow through the display container, but it is preferably arranged to be continuous outside the display container. In this case, a flow may be guided to the dispensing device through a suitable valve, when desired, and a similar flow may be guided through a valve to the display container at suitable intervals. These intervals may be used for adjusting the thickness and the appearance of the layer of ice created on the surface of the display container.

Preferably, a part of the pipework circulating the alcoholic drink comprises an open-top return pipe positioned in the display container and extending in an upward direction. The alcoholic drink flowing into the display container can exit said container through the open upper end of the pipe, the level of the open upper end thereby determining the alcoholic drink level in the display container. The temperature of the circulating alcoholic drink being cooled significantly below the ambient temperature, the temperature of the display container is equally low below the alcoholic drink level in the container. Humidity of the ambient air causes thus a layer of ice to build up on the outer surface of the display container throughout the cold alcoholic drink portion, the maximum level of the layer being thus determined by the length of the return pipe. Since the return pipe works gravitationally, the display container is always unpressurized, which guarantees that the display container does not break during the initial cooling stage of the apparatus or during warming to the room temperature after being switched off.

Preferably, the display container is a trans-parent glass container with a closed upper end and an opening bottom end, such as a bottle turned upside down, all stream flow in and out of said bottle taking place only through the opening and tightly closing bottom end of the container. A preferred solution is to use the original package of the served alcoholic drink or a reproduction thereof as the display container. Also non-transparent display containers and containers made from other material than glass may be used. The known product, with its brand and package, is thus well presented at the bar counter. In particular, by adjusting the height of the return pipe such that the label of the package, such as the bottle, or at least a part of the label, is clearly visible and allowing the ice to build up only below this level, a temptingly icy serve effect is achieved, directly from the very bottle of the known brand.

In practice, the alcoholic drink container capacity is significantly larger than the display container capacity and may be for example from 5 to 20 liters or even more. The alcoholic drink container is preferably an unpressurized opening and closing container, to which alcoholic drink may be added as per consumption at regular intervals, i.e. at any time, without interfering with the use of the dispenser. Adding alcoholic drink to the alcoholic drink container at room temperature does not affect the temperature of the served alcoholic drink, because alcoholic drink flows from the alcoholic drink container to the display container through a separate cooler, which is preferably sized such that the temperature of alcoholic drink coming out of the cooler is always as desired and constant, for example from −1° to −20° C. for spirits.

In one embodiment, the dispensing device is connected to the display container such that the drink is drawn directly from the display container. The drink may, of course, also be drawn from other such parts of the alcoholic drink flow in which the alcoholic drink temperature is constant, for instance from the flow pipe after the cooler.

As has been described above, the length of the return pipe, i.e. the level of its upper end, determines the level of the ice layer forming on the display container surface. In one embodiment of the invention, the return pipe therefore comprises a length adjustment, for instance a telescopic adjustment, for adjusting the alcoholic drink level in the display container. The portion covered by the ice layer in a specific bottle can thus be adjusted and even shifted up and down during the same night, and the length of the return pipe can be adapted according to display containers of different sizes.

The display container, such as a bottle turned upside down, is supported on a suitable base and a support element, not described any further in this context. The support element under the display container may have illuminators, such as LEDs, directed at the alcoholic drink in the display container and possibly at the layer of ice covering the display container. By selecting the color and the intensity of the lights to suit the specific served alcoholic drink and its temperature, the images contributing to the selection of the alcoholic drink at the bar counter may be significantly emphasized. The lights can also be arranged inside the display container containing the served alcoholic drink by placing the illuminators for instance in conjunction with the return pipe.

Since the formation of the layer of ice is quite inconsistent in different humidity conditions, it is possible to use an adjustment, such as for adjusting the cooler temperature, pump power, timing of the bottle recirculation in the dispenser, to contribute to the formation of the ice layer. Adjustments can be made manually, in which case the waiter can make the adjustments as they wish. Adjustments may also be programmed to work automatically, in which case bottle recirculation is adjusted for example according to the outside temperature and the ambient humidity. The adjustment can also be based on by optically observing the thickness of the layer of ice or by weighing the total mass of the display container and the ice, and basing the adjustment on the result. The layer of ice may also be adjusted according to the temperature on the bottle surface. The appearance of the layer of ice may also be changed depending on the adjustment used. If ice is allowed to form on the container surface without any interruptions, a white snow-like layer of ice is created, but if cyclic circulation is used, i.e. cooling is switched off for example for about 30 minutes and on for 5 minutes, a transparent layer of ice is achieved.

The dispenser in accordance with the invention has significant advantages over the prior art. Firstly, the device does not require for separate cooling glycol circulation, such as is the case with the similar known dispensers, but uses instead the served alcoholic drink as circulating fluid. The required cooler is therefore as easily serviced as possible. Secondly, there is no need for changing the bottles in the system, but instead the cold dispensing bottle is always displayed and alcoholic drinks are added to the container elsewhere, the changing process not being seen by the customers. Thirdly, alcoholic drinks may always be served directly from the original package, or at least understood as such by the customers. Fourthly, the served product is always well displayed at the bar counter in its original package, and yet is kept very cold. Fifthly, the bottle containing the product can be kept at room temperature thus giving room to other products in the cold store. Furthermore, changing the product to another one is relatively easy, because only line cleaning and a new display container for the specific alcoholic drink and a new bottle containing the product are required.

### LIST OF FIGURES

In the following, the invention will be described in detail using an example and with reference to the accompanying drawings, in which

FIG. 1 represents a schematic and partial section view of a dispenser in accordance with the invention for serving cold alcoholic drinks, and

FIG. 2 represents a schematic view of another embodiment of the invention.

### DETAILED DESCRIPTION OF THE INVENTION

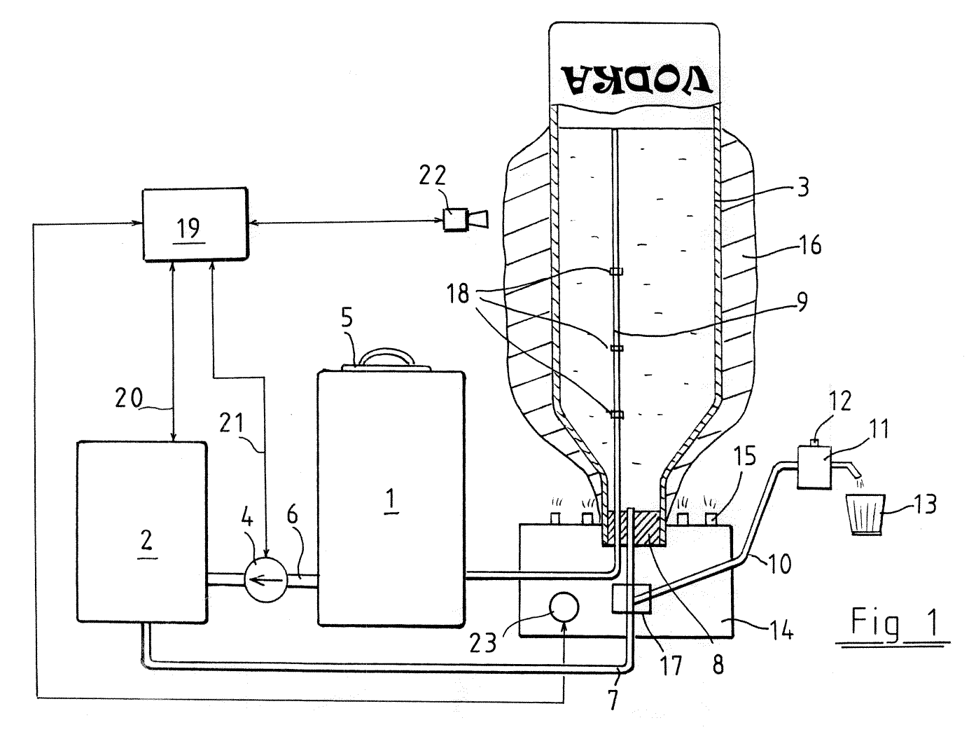

FIG. 1 shows a schematic view of a dispenser in accordance with the invention. It is to be noted that the scale of the figure does not correspond to the actual scale, instead, for the sake of clarity, the display container is drawn larger than the actual size. Furthermore, the embodiment shown in the figure describes the invention in the case where the served alcoholic drink is served at below 0° C., such that a layer of ice is formed on the surface of the display container.

The dispenser comprises an unpressurized alcoholic drink container 1, equipped with a closing and opening lid 5, to which container the dispensed alcoholic drink may be added at need through the lid. A hose 6 parts from the alcoholic drink container, to which hose a pump 4 is connected for pumping alcoholic drink to a cooler 2. The cooler may be, for instance, a known cooler using glycol as a medium and able to sufficiently lower the temperature of the pumped alcoholic drink, usually to the range of from −5 to −15° C. Cold alcoholic drink is guided from the cooler to a bottle, which is turned upside down and serves as a display container 3, the bottle preferably being the original package of the served alcoholic drink or a larger reproduction thereof.

A hose 7 is directed from the cooler to the bottle 3 through a mouthpiece 8 tightly fitted to the mouth of said bottle. A return pipe or an overflow pipe 9 is also directed through the same mouthpiece 8, said return pipe leading from the display container 3 back to the alcoholic drink container 1. The return pipe 9 is a straight pipe extending to a specific level in the bottle. Due to the open upper end of the pipe 9, the alcoholic drink pumped to the bottle and exceeding the pipe level is able to flow freely down the return pipe 9 and back to the alcoholic drink container. The position of the open upper end of the return pipe thus determines the alcoholic drink level in the bottle.

A three-way valve 17 is attached to the hose 7 before directing it through the mouthpiece to the display container, a third flow pipe 10 parting from the valve and leading to a known dispensing device 11, which allows, for example by pushing a button 12, for dispensing 4 cl of ice-cold alcoholic drink into a glass 13.

The display container 3 is supported on a suitable support base 14. Illuminators 15, such as LEDs, are attached to the support base, which illuminators are directed upwards at the display container 3. In this embodiment, illuminators 18 are also placed on the return pipe 9 inside the display container containing the served alcoholic drink.

When using the dispenser, the cold alcoholic drink flows and circulates from the alcoholic drink container 1 through the pump 4 and the cooler 2 to the display container 3 and through the return pipe 9 back to the alcoholic drink container 1. The temperature of the display container under the alcoholic drink level being below the freezing point of water, ice 16 begins to build up on the outer surface of said container, the rate and layer thickness of icing depending above all on humidity of the ambient air. When using the dispenser usually over a temperature range of +20-+40° C., the upper portion of the display container, or the area not containing any alcoholic drink, does not build up ice, but stays instead clear and ice-free. By adjusting the alcoholic drink level this way, the desired information of the served product, such as the name, the brand, the original bottle shape, etc. are thus displayed in the original package.

The temperature of the alcoholic drink flowing through the cooler 2 is always constant, so the temperature of the alcoholic drink taken from the hose 7 through the three-way valve 17 is always constant as well and may be served through the dispensing device 12.

The appeal of the alcoholic drink presented in the dispenser may be emphasized even more with the illuminators 15 supported on the support base 14, which illuminators can be used for directing lights of desired colors both at the alcoholic drink and the layer of ice 16 covering the display container. The tone of the served alcoholic drink may further be accentuated by the lights 18 inside the display container.

FIG. 1 also shows a schematically drawn adjustment 19 enabling the adjustment of the device and, similarly, the thickness of the layer of ice 16 created on the display container surface. The adjustment may comprise a direct power adjustment 20 for the cooler 2, or a direct power adjustment 21 for the pump 4, both contributing directly to the thickness of the layer of ice. In addition to these, the thickness of the layer of ice may be measured by a direct optical measurement 22 or by a suitable indirect measurement 23 positioned in the support base 14 of the device. The indirect measurement may be based, as is shown in the figure, on weight measurement.

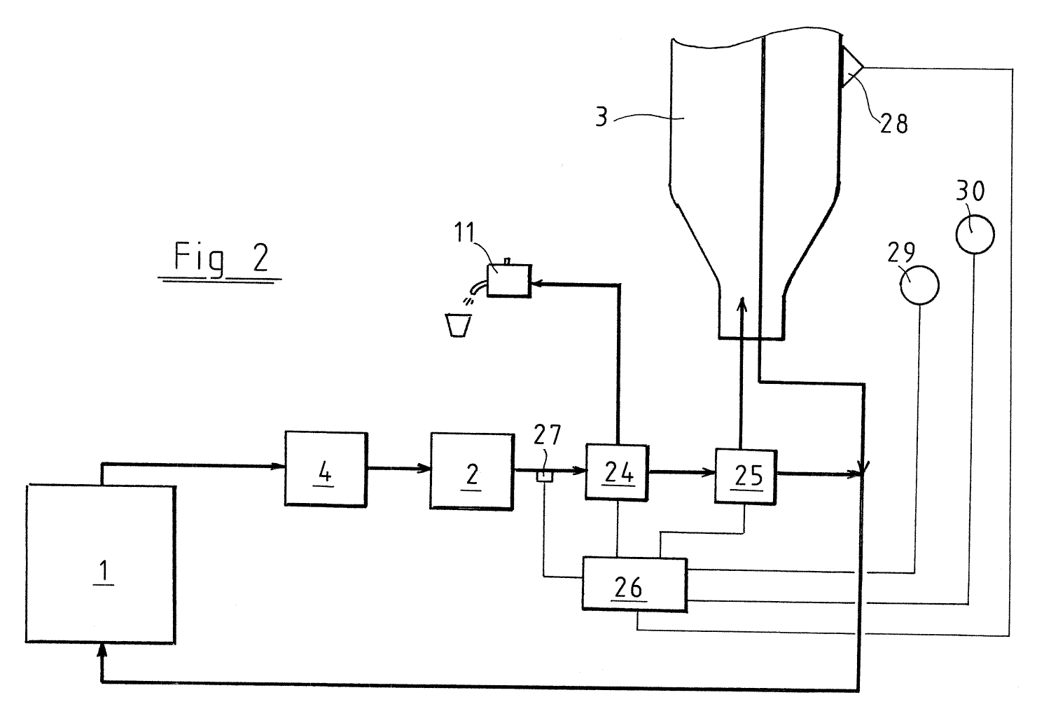

In another embodiment of the invention, shown in FIG. 2, the alcoholic drink container 1, the pump 4 and the cooler 2 form together a fluid circulation excluding the display container 3, to which fluid circulation a first three-way valve 24 is positioned in the flow direction after the cooler 2, from which valve a stream flow for dispensing may be guided to the dispensing device 11. The fluid circulation comprises thereafter another three-way valve 25, from which the stream flow may be directed either to run directly back to the alcoholic drink container 1, or to the display container 3, from which it is able to flow, according to the embodiment of FIG. 1, back to the alcoholic drink container through the return pipe 9.

Continuous circulation of the cold fluid to be dispensed guarantees that the entire system is kept cold, so that the first drink served even after a long pause is also cold. In this embodiment, there is no need for a pump or a cooler adjustment, instead both three-way valves 24 and 25, and potentially a flow indicator 27, a temperature sensor 28 on the bottle 3 surface, and a thermometer 29 and hygrometer 30 of the ambient air are engaged in the adjustment unit 26.

The appearance of the display container 3 may easily be adjusted with the device of FIG. 2 by using the other three-way valve 25 to adjust the alcoholic drink flow at times directly to the alcoholic drink container, and some other times to the alcoholic drink container through the display container 3. Depending on the intervals used and the ambient air conditions, a zone of permanent ice may thus be formed on the lower part of the display container, a reshaping zone of ice varying by thickness and height in the middle part, and a bare zone in the upper part, throughout which the container used is clearly visible. It is, of course, also possible to keep the fluid level in the display container at such a height and to cool it to such an extent that the entire container will be covered by the layer of ice.

The invention is not limited merely to the examples referred to above, instead many variations are possible within the scope of the inventive idea defined by the claims.

1. A dispenser for dispensing cooled alcoholic drinks, characterized in that the dispenser comprises a alcoholic drink container, a cooler for cooling the alcoholic drink to below 0° C., a display container for displaying the served alcoholic drink, a pump for circulating alcoholic drink from the alcoholic drink container through the cooler to the display container and back to the alcoholic drink container such that humidity of the ambient air that builds up on the outer surface of the display container freezes, forming a layer of ice, and a dispensing device connected to alcoholic drink circulation for dispensing a drink.

2. The dispenser according to claim 1, characterized in that the pump is arranged between the alcoholic drink container and the cooler to pump alcoholic drink from the alcoholic drink container through the cooler to the display container.

3. The dispenser according to claim 1, characterized in that the display container comprises a return pipe extending upwards, the level of the open upper end of which pipe determining the alcoholic drink level in the display container and similarly the upper edge of the layer of ice built up on the display container surface and caused by humidity of the air.

4. The dispenser according to claim 1, characterized in that the display container is a glass container with a closed upper end and an opening bottom end, such as a bottle turned upside down.

5. The dispenser according to claim 4, characterized in that the display container is the original package of the served alcoholic drink or a reproduction thereof.

6. The dispenser according to any claim 1, characterized in that the dispensing device is connected to the display container for drawing a drink from the display container.

7. The dispenser according to claim 3, characterized in that the return pipe comprises a length adjustment for adjusting the alcoholic drink level in the display container and adapting the length of the return pipe according to display containers of different sizes.

8. The dispenser according to any claim 1, characterized in that illuminators, such as LEDs, are arranged in conjunction with the display container for lighting the alcoholic drink in the display container and the layer of ice covering the display container.

9. The display container according to claim 1, characterized in that the dispenser comprises an adjustment, such as a cooler temperature adjustment or a pump power adjustment, for adjusting the thickness of the layer of ice.

10. The dispenser according to claim 9, characterized in that the adjustment comprises a direct or an indirect measurement of the thickness of the layer of ice.

11. The dispenser according to claim 1, characterized in that the dispensing device is connected to fluid circulation excluding the display container.

12. The dispenser according to claim 11, characterized in that the fluid circulation excluding the display container comprises an adjustment valve for guiding the fluid circulation to pass through the display container.
